(19) United States
(12) Patent Application Publication
(10) Pub. No.: US 2002/0172221 A1
(43) Pub. Date: Nov. 21, 2002

(54) Distributed communication device and architecture for balancing processing of real-time communication applications

(75) Inventors: Michele Zampetti Dale, Quakertown, PA (US); Farrukh Amjad Latif, Lansdale, PA (US)

Correspondence Address: HITT GAINES & BOISBRUN P.C., P.O. BOX 832570, RICHARDSON, TX, 75083, US

(73) Assignee: TelGen Corporation, Lansing, MI

(21) Appl. No.: 09/860,886

(22) Filed: May 18, 2001

(51) Int. Cl. H04J 3/22

(52) U.S. Cl. 370/466; 370/386

(57) ABSTRACT

A device, architecture and system that efficiently supports voice, video, and non-real-time data streams between networks and/or devices in one or more multiple protocol environments. Several interconnected functional blocks that are programmably configuable to perform portions of processing appurtenant to one or more of the protocol environments. A function allocator, associated with the plurality of functional blocks, allocates portions or processing among the functional blocks based on an identity of one or more of the protocol environments. The device may be employed in many data communication-processing environments, I/O processors in computers, and is especially well suited as gateway device for processing real-time communication as well as bursty data between networks and customer premise equipment.

### CROSS-REFERENCE TO RELATED PATENT APPLICATIONS

This patent application is related to the following pending applications, which (i) are assigned to the same assignee as this application, (ii) were filed concurrently with this application; and (iii) are incorporated herein by reference as if set forth in full below:

Attorney Docket No. TELG-0002, U.S. application Ser. No. ______, entitled “System Interconnect With Minimal Overhead Suitable For Real-Time Applications” to Michele Zampetti Dale, et. al.

Attorney Docket No. TELG-0004, U.S. application Ser. No. ______, entitled “System And Method For Providing Non-Blocking Shared Structures” to Michele Zampetti Dale, et. al.

Attorney Docket No. TELG-0011, U.S. application Ser. No. ______, entitled “Dynamic Resource Management And Allocation In A Distributed Processing Device” to Michele Zampetti Dale, et. al.

Attorney Docket No. TELG-0018, U.S. application Ser. No. ______, entitled “System and Method for Coordinating, Distributing and Processing of Data” to Stephen Doyle Beckwith, et. al.

### BACKGROUND OF THE INVENTION

1. Field of the Invention

The present invention relates generally to a data processing architecture and system, and more particularly, to a communication device and system for managing data communication and processing.

2. Related Art

Internet telephony service providers have yet to provide real-time communication, such as voice and video, beyond the “fledgling technology” stage. For example, internet telephone service providers transported 1.6 billion minutes of voice over IP (VOIP) traffic worldwide in November of 2000. Whereas, in the United States alone, the amount of traffic transmitted over public switched telephone networks (PSTN) amounted to about 3.6 trillion minutes of voice conversation for the same month. Overall, internet telephone service providers' voice traffic account for less than one percent of all real-time communication traffic worldwide.

One reason internet access providers lag behind traditional PSTN providers is their ability to provide reliable quality of service. Real-time communication, such as voice and video, are typically routed over many linked networks from a source to a final destination. Real-time communication is very sensitive to accumulated delay, which is commonly referred to as latency. Processing delays of real-time communication during transport can cause serious quality problems such as dropped data that can result in unintelligible speech, skewed video and other related quality of service problems. Effective data transportation with improved latencies is a key to improving quality of service for packet/cell centric real-time communication systems.

Applications such as Multi-Service Access Platforms (MSAP), Customer Premise Equipment (CPE), may handle multiple voice conversations, computer data transportation and video simultaneously. The problem facing such equipment is how to deal with multiple media and data protocols running at different clock speeds with dissimilar priorities and protocols. For example, computer data or non-real-time data such as e-mail or web page downloads may compete with real-time multi streaming data such as voice and video. All three medias, voice, video and computer data, are typically transported in accordance with very dissimilar protocols and data rates.

Most communication devices attempt to deal with such multi streaming data with computer systems architectures that were originally designed for data processing applications and number crunching dating back over 30 years ago. In other words, such devices often borrow their designs and operation from conventional computer data processing environments and attempt to apply them to real-time communication environments. When handling as little as two voice channel conversations simultaneously, these devices are often taxed beyond their processing capability. Although this is not a problem for non-real-time data such as e-mail, packet-switched networks commonly inject a delay as much as a half second between speaking and being heard at the other end. Of course, this makes conversations or video transactions very dissatisfying.

Another disadvantage with communication devices based on conventional computer architecutres is that they tend to employ a primary processor as the master of the system. As a result, almost all control overhead associated with various protocol related data must flow through the master processor adding to the bottleneck affect and contention for the availability of this processor.

Moreover, if the processor is busy servicing a data transfer, data from other real-time sources must wait their turn until the processor is able to handle their requests or interrupt the current data transfer. If the current transfer consists of real-time data, processor interrupts can cause this real-time communication to be halted. Thus, voice or video will either be delayed extensibly or data packets will be dropped making it unintelligible. Furthermore, the processor may be required to devote all its operating bandwidth to real-time data, effectively starving out any other execution processing like e-mail or file transfers that also require the processor. Peripheral devices connected to the processor that may need to concurrently rely on it may likewise be starved out. If the processor is unable to execute tasks associated with such other devices, data may overrun the buffers of such devices and cause it to be lost forever.

Faster clock rates are often employed to counter act the problems of processor interrupts and contention for busses, but this creates other problems such as higher power consumption and hotter chips. Moreover, higher clock speeds partially solve some inherent problems associated with most traditional communication devices that translate into performance ill suited for real-time communication with acceptable quality of service.

A large majority of communication systems utilize shared bussed architectures. As a result bottlenecks and jamming of data occur when multiple devices contend for clear access to a shared bus. Prioritized data from a real-time communication application typically starves out access to busses for non-priority data associated with non-real-time applications.

In essence, most systems today borrow their ability to process multiple streaming data from classic data processing systems and, as a result, such systems are inadequate to deal with real-time streaming media.

What is needed, therefore, is a new communication device with architectures and functionality able to handle processing of real-time data communication concurrently with non-real-time data without the problems found in most current systems as described above. Preferably, such a device is able to converse and simultaneously support communication between multiple protocol environments.

### SUMMARY OF THE INVENTION

The present invention is directed to an improved communication device to efficiently process multi media information. The present invention may be adopted for use in many different environments to effectuate proficient processing of information. In an illustrative embodiment, the present invention is used as a gateway device supporting voice, video, and non-real-time data streams between networks and/or devices.

In one embodiment of the present invention, a communication device is used for communicating in several protocol environments. The device comprises several interconnected functional blocks that are programmably configuable to perform portions of processing appurtenant to one or more of the protocol environments. A function allocator, associated with the plurality of functional blocks, allocates portions or processing among said functional blocks based on an identity of one or more of the protocol environments.

An advantage of the present invention is the ability to statically or dynamically distribute and balance real-time functionalities among several programmable functional blocks. This reduces latencies of the device by processing real-time communication data immediately with as little delay as possible. Accordingly, no one functional element of the communication device is over saturated with processing tasks. In other words, unlike conventional processing devices, the present invention dynamically distributes and adjusts tasks associated with multiple streaming media to various interconnected functional blocks so that no one functional block or the main processor becomes over consumed with processing control data.

Each function block augments primary processor(s), such as the central processor(s) or digital signal processors, by off-loading protocol sensitive or other specialized computation from such devices. As an intelligent protocol engine, each functional block is configured to support protocols appurtenant to real-time communication or other tasks necessary to better distribute and balance functionality. As a specialized functional engine, like encryption, the functional block is configured to support precisely this function and its variants. The functional blocks use largely common hardware and firmware for scalability and simplicity. Each functional block can be programmed and are typically configured to support processing of real-time applications. Each functional block can be reconfigured in the event a bug is detected or further adjustments need to be made to the device.

Another advantage of the present invention is that the main processor operates in a peer-to-peer relationship with the functional blocks, reducing reliance on the processor for real-time applications, eliminating delays caused by interrupts, reducing redundant processing of control data associated with the payload of real-time data, and minimizing the need to store and restore data in memory. In other words, a peer-to-peer relationship relieves the need to funnel everything through the processor. Furthermore, intermediate data flow is reduced because most real-time data bypasses the main processor completely, again eliminating delays associated with the processor.

A further advantage of the present invention, in one illustrative embodiment is the use ofa cross bar connection for point-to-point communication of real-time data. Although not absolutely required, the cross bar can substantially eliminate bottlenecks associated with the use of shared busses. Real-time data can be instantaneously (e.g. in one clock cycle) switched from one device to another. Data rates can flow throughout the communication system without having to arbitrate and wait for availability of internal busses. This also reduces the need to provide intermediate storage (memories) between the functional blocks, thus reducing latency.

Still another advantage of the present invention, is an area-efficient and low power architecture with redundant scalability of the functional blocks. Thus, the present invention can be embedded on a single chip as a “system-on-a-chip” and be configured to handle many different applications without major modifications to its design and architecture.

Other features and advantages of the present invention as well as further embodiments will become apparent after reading the Detailed Description of the Preferred Embodiments section below.

### BRIEF DESCRIPTION OF THE DRAWINGS

The present invention will be described with reference to the accompanying drawings, wherein:

FIG. 1 shows a multi-protocol environment that a communication device may be employed, in accordance with one embodiment of the present invention.

FIG. 2 is a block diagram of a communication device according to a an illustrative embodiment of the present invention.

FIG. 3 is a block diagram of sample hardware used in an Intelligent Protocol Engine in accordance with an illustrative embodiment of the present invention.

FIG. 4 shows a lower-level block diagram of an Intelligent Protocol Engine, according to an illustrative embodiment of the present invention.

FIG. 5 is a functional architecture block diagram illustrating how primary functional attributes are partitioned in a communication device according to an illustrative embodiment of the present invention.

FIG. 6 is a flow diagram representing initialization of a communication device according to an illustrative embodiment the invention.

FIG. 7 is a high-level block diagram representing queues employed in a task manager module according to one embodiment of the present invention.

FIG. 8 is a flow diagram illustrating high-level functionality of an intelligent protocol engine in relation to other system elements according to an illustrative embodiment of the present invention.

FIG. 9 is a block diagram of a multi-protocol environment showing example traffic paths taken as data transcends protocol layers of functionality performed in intelligent protocol engines, according to one embodiment of the present invention.

FIG. 10 is a block diagram of an interface access device showing example data flow according to one embodiment of the present invention.

### DETAILED DESCRIPTION OF THE PREFERRED EMBODIMENTS

The following description is presented to enable a person skilled in the art to make and use the invention, and is provided in the context of a particular application and its requirements. Various modifications to the preferred embodiment will be readily apparent to those skilled in the art and the general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

All terms used through this specification shall receive their ordinary meaning unless described otherwise therein. For purposes of a general understanding and to avoid having to redefine things, as used throughout this document, “data” generally refers to streaming data, such as audio and video, including payloads associated with such media and also bursty data, such as data processing used in such systems. Other usages of “data” shall be described in more detail below.

“Protocols” generally refer to industry standard formats governing the exchange of data, but are not limited to industry standards. Protocols for data communication typically address framing, error handling, packet handling, cell filtering and other rules commonly adapted for communication.

“Peer-to-Peer” generally means a relationship between devices where neither device is a slave nor a master to the other in most applications.

“Real-time” communication generally refers to communication that is conducted with no perceived delay in the transmission of messages or in the response to it, such as a voice telephone conversation.

“Streaming media” generally refers broadly to audio or video (real-time data) sent in the form of packets or cells with a definitive relation to time.

The preferred embodiments of the invention are now described with reference to the figures where like reference numbers indicate identical or functionally similar elements. Also in the figures, the left most digit of each reference number corresponds to the figure in which the reference number is first used.

The present invention may be used in almost any application that requires real-time speed and efficiency. It is envisioned that the present invention may be adopted for various roles, such as routers, gateways and I/O processors in computers, to effectively transmit and process data; especially streaming media. One feature of the present invention is its ability to be applied in an environment where there is a need to support transmission and receipt of real-time data in conjunction with non-real-time data.

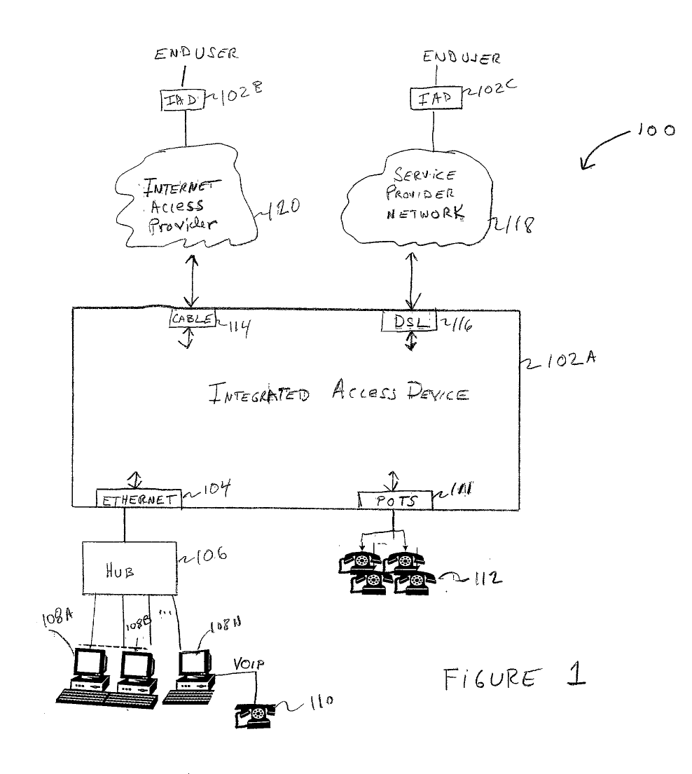

FIG. 1 shows a multi-protocol environment 100 where a communication device 102 may be employed, in accordance with one embodiment of the present invention. In this example, communication device 102 is an integrated access device (IAD) that bridges two networks. That is, IAD 102 concurrently supports voice, video and data and provides a gateway between other communication devices, such as individual computers 108, computer networks (in this example in the form of a hub 106) and/or telephones 112 and networks 118, 120. In this example, IAD 102A supports data transfer between an end user customer's site (e.g., hub 106 and telephony 112) and internet access providers 120 or service providers' networks 118 (such as Sprint Corp., AT&T and other service providers). More specifically, IAD 102 is a customer premise equipment device supporting access to a network service provider.

Nevertheless, it is envisioned that IAD 102 may be used and reused in many different types of protocol gateway devices, because of its adaptability, programmability and efficiency in processing real-time data as well as non-real-time data. As shall become appreciated to one skilled in the art, the architecture layout of device 102 (to be described in more detail below) may very well serve as a footprint for a vast variety of communication devices including computers.

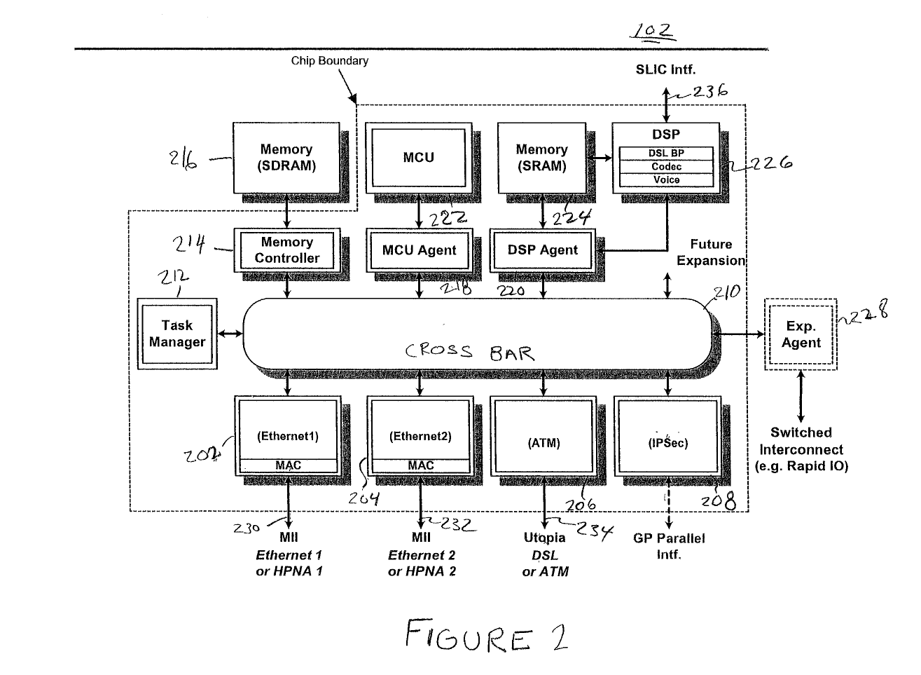

FIG. 2 is a block diagram of device 102 according to an illustrative embodiment of the present invention. Device 102 is preferably implemented on a single integrated chip to reduce cost, power and improve reliability. Device 102 includes intelligent protocol engines (IPEs) 202-208, a cross bar 210, a function allocator (also referred to as a task manager module (TMM)) 212, a memory controller 214, a Micro Control Unit (MCU) agent 218, a digital signal processor agent 220, a MCU 222, memory 224 and a DSP 226.

External memory 216 is connected to device 102. External memory 216 is in the form of synchronized dynamic random access memory (SDRAM), but may employ any memory technology capable of use with real-time applications. Whereas, internal memory 224 is preferably in the form of static random access memory, but again any memory with fast access time may be employed. Generally, external memory 216 is unified (i.e., MCU code resides in memory 216 that is also used for data transfer) for cost sensitive applications, but local memory may be distributed throughout device 102 for performance sensitive applications such as internal memory 224. Local memory may also be provided inside functional blocks 202-208, which shall be described in more detail below.

Also shown in FIG. 2, is an expansion port agent 228 to connect multiple devices 102 in parallel to support larger hubs. For example, in a preferred embodiment, device 102 supports 4 POTS, but can easily be expanded to handle any number of POTS such as a hub. Intelligent protocol engines 202-208, task manager 212 and other real-time communication elements such as DSP 226 may also be interchangeably referred to throughout this description as “functional blocks.”

Data enters and exits device 102 via lines 230-236 to ingress/egress ports in the form of IPEs 202-206 and DSP 226. For example voice data is transmitted via a subscriber line interface circuit (SLIC) line 236, most likely located at or near a customer premise site. Ethernet type data, such as video, non-real-time computer data, and voice over IP, are transmitted from data devices (shown in FIG. 1 as computers 108) via lines 230 and 232. Data sent according to asynchronous transfer mode (ATM), over a digital subscriber line (DSL), flow to and from service provider's networks or the internet via port 234 to device 102. Although not shown, device 102 could also support ingress/egress to a cable line (not shown) or any other interface.

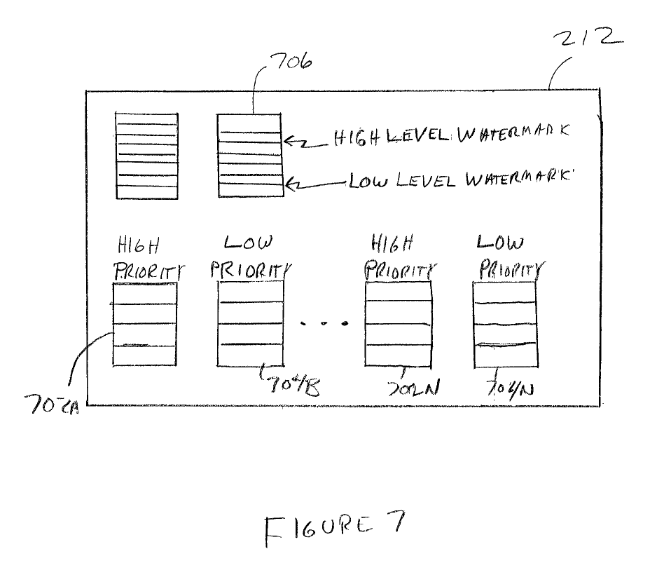

The general operation of device 102 will be briefly described. Referring to FIG. 2, device 102 provides end-protocol gateway services by performing initial and final protocol conversion to and from end-user customers. Device 102 also routes data traffic between an internet access/service provider network 118, 120, shown in FIG. 1. Referring back to FIG. 2, MCU 222 handles most call and configuration management and network administration aspects of device 102. MCU 222 also may perform very low priority and non-real-time data transfer (e.g., control type data) for device 102, which shall be described in more detail below. DSP 226 performs voice processing algorithms and interfaces to external voice interface devices (not shown). IPEs 202-208 perform tasks associated with specific protocol environments appurtenant to the type of data supported by device 102 as well as upper level functions associated with such environments. TMM 212 manages flow of control information by enforcing ownership rules between various functionalities performed by IPEs 202-208, MCU 222 or DSP 226. [0047] With high and low level watermarks (described in more detail below and with reference to FIG. 7), TMM 212 is able to notify MCU 222 if any IPE 202-208 is over or under utilized. Accordingly, TMM 212 is able to ensure dynamic balancing of tasks performed by each IPE relative to the other IPEs.

Most data payloads are placed in memory 216 until IPE's complete their assigned tasks associated with such data payload and the payload is ready to exit the device via lines 230-236. The data payload need only be stored once from the time it is received until its destination is determined. Likewise time critical real-time data payloads can be placed in local memory or buffer (not shown in FIG. 2) within a particular IPE for immediate egress/ingress to a destination or in memory 224 of the DSP 226, bypassing external memory 216. Most voice payloads are stored in internal memory 224 until IPEs 202-208 or DSP 226 process control overhead associated with protocol and voice processing respectively.

A cross bar 210 permits all elements to transfer data at the rate of one data unit per clock cycle without bus arbitration further increasing the speed of device 102. Cross bar 210 is a switching fabric allowing point-to-point connection of all devices connected to it. Cross bar 210 also provides concurrent data transfer between pairs of devices. In a preferred embodiment, the switch fabric is a single stage (stand-alone) switch system, however, a multi-stage switch system could also be employed as a network of interconnected single-stage switch blocks. A bus structure or multiple bus structures (not shown) could also be substituted for cross bar 210, but for most real-time applications a crossbar is preferred for its speed in forwarding traffic between ingress and egress ports (e.g., 202-208, 236) of device 102. Device 102 will now be described in more detail.

In traditional computer environments, processing involves approximately 20-to-30 percent control overhead and the rest data movement for a typical transaction. On the other hand, with real-time communication, almost 80% of the processing involves control overhead and the rest involves data movement. As mentioned in the Background section, typical architectures have the central processor as a master and everything else falls under its domain. In device 102, MCU 222 is essentially a central processor unit; however, MCU 222 is primarily responsible for overall system operation of device 102 and housekeeping functions. Whereas, IPEs 202-208 primarily handle specific real-time control functions associated with multiple protocol environments. This relieves MCU 222 of the burden of processing and tracking massive amounts of overhead and control information. It also permits MCU 222 to concentrate on managing optimal operation of device 102. MCU 222 primarily manages performance by handling resource management in an optimum way, initialization and call set-up/tear-down all in non-real time mode. Off-the-shelf communication processors from readily available commercial sources can be employed as MCU 222. MCU 222 is also used to reassign tasks to IPEs 202-208, in the event task manager 212 notifies MCU 222 that any one of the IPEs 202-208 are over or under utilized.

MCU 222 is connected to an MCU agent 218 that serves as an adapter for coupling MCU 222 to cross bar 210. Agent 218 makes the cross bar 210 transparent to MCU 222 so it appears to MCU 222 that it is communicating directly with other elements in device 102. As appreciated by those skilled in the art, agent 218 may be implemented with simple logic and firmware tailored to the particular commercial off-the-shelf processor selected for MCU 222.

DSP 226 may be selected from any of the off-shelf manufactures of DSPs or be custom designed. DSP 226 is designed to perform processing of voice and/or video. In the embodiment shown in FIG. 2, DSP 226 is used for voice operations. DSP agent 220 permits access to and from DSP 226 from the other elements of device 102. Like MCU agent 218, DSP agent 220 is configured to interface with the specific commercial DSP 226 selected. Those skilled in the art appreciate that agent 220 is easily designed and requires minimal switching logic to enable an interface with cross bar 210.

TMM 212 acts as a function coordinator and allocator for device 102. That is, TMM 212 tracks flow of control in device 102 and associated ownership to tasks assigned to portions of data as data progresses from one device (e.g., 202) to another device (e.g., 226).

Additionally, TMM 212 is responsible for supporting coordination of functions to be performed by devices connected to cross bar 210. TMM 212 employs queues to hand-off processing information from one device to another. So when a functional block (e.g., 202-208 & 222) needs to send information to a destination outside of it (i.e., a different functional block) it requests coordination of that information through TMM 212. TMM 212 then notifies the device, e.g., IPE 202 that a task is ready to be serviced and that IPE 202 should perform the associated function. When IPE 202 receives a notification, it downloads information associated with such tasks for processing and TMM 212 queues more information for IPE 202. As mentioned above, TMM 212 also controls the logical ownership of protocol specific information associated with data payloads, since device 102 uses shared memory. In essence this control enables TMM 212 to perform a semaphore function.

It is envisioned that more than one TMM 212 can be employed in a hub consisting of several devices 102 depending on the communication processing demand of the application. In another embodiment, as mentioned above, a high and low water mark in TMM 212 can be used to ascertain whether any one functional block is over or under-utilized. In the event either situation occurs, TMM 212 may notify MCU 222 to reconfigure IPEs 202-208 to redistribute the functional workload in more balanced fashion. In a preferred embodiment, the core hardware structure of a TMM 212 is the same as IPEs 202-208, described in more detail as follows.

IPEs 202-208 are essentially scaled-down area-efficient micro-controllers specifically designed for protocol handling and real-time data transfer speeds. IPEs 202 and 204 are assigned to provide ingress/egress ports for data associated with an Ethernet protocol environment. IPE 206 serves as an ingress/egress port for data associated with an ATM protocol environment. IPE 208 performs a collection of IP security measures such as authentication of headers used to verify the validity of originating addresses in headers of every packet of a packet stream. Additional, IPEs may be added to device 102 for added robustness or additional protocol environments, such as cable. The advantage of IPEs 202-208 is that they are inexpensive and use programmable state machines, which can be reconfigured for certain applications.

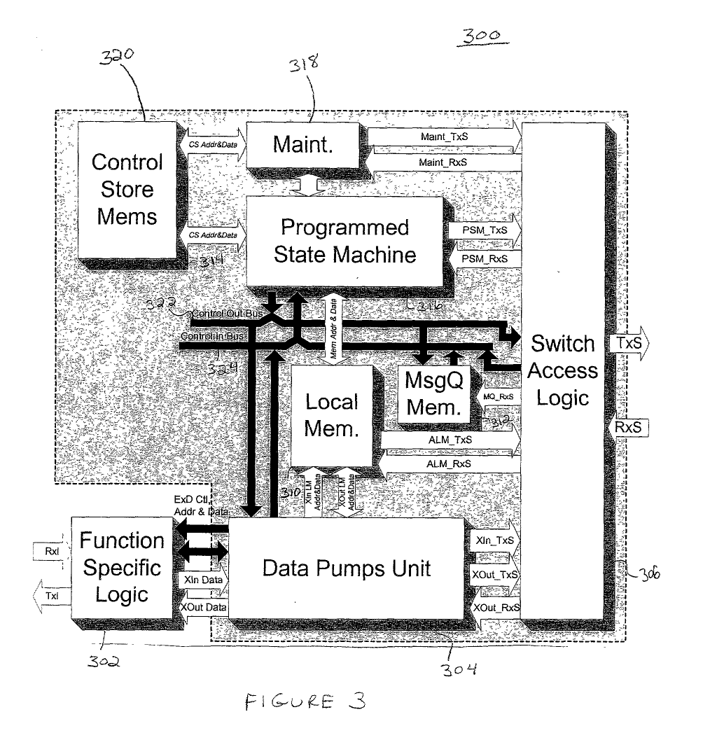

FIG. 3 is a block diagram of sample hardware used in an IPE 300 in accordance with a preferred embodiment of the present invention. Other than interface specific hardware, it is generally preferred that the hardware of IPEs remain uniform. IPE 300 includes: an interface specific logic 302, a data pump unit 304, switch access logic 306, local memory 310, a message queue memory 312, a programmed state machine 316, a maintenance block 320, and control in and out busses 322, 324. Each element of IPE 300 will be described in more detail with reference to FIG. 3. Programmed state machine 316 is essentially the brain of an IPE. It is a micro-programmed processor. IPE 300 may be configured with instruction words that employ separate fields to enable multiple operations to occur in parallel. As a result, programmed state machine 316 is able to perform more operations than traditional assembly level machines that perform only one operation at a time. Instructions are stored in control store memory 320. Programmed state machine 316 includes an arithmetic logic unit (not shown, but well known to those skilled in the art) capable of shifting and bit manipulation in addition to arithmetic operations. Programmed state machine 316 controls most of the operations throughout IPE 300 through register and flip-flop states (not shown) in IPE via Control In and Out Busses 322, 324. Busses 322, 324 in a preferred embodiment are 32 bits wide and can be utilized concurrently. It is envisioned that busses 322, 324, be any bit size necessary to accommodate the protocol environment or function to be performed in device 102. It is envisioned, however, that any specific control or bus size implementation could be different and should not be limited to the aforementioned example.

Switch access logic 306 contains state machines necessary for performing transmit and receive operations to other elements in device 102. Switch access logic 306 also contains arbitration logic that determines which requester within IPE 300 (such as programmed state machine 316 or data pump unit 304) obtains a next transmit access to cross bar 210 as well as routing required information received from cross bar 210 to appropriate elements in IPE 300.

Maintenance block 318 is used to download firmware code that is downloaded during initialization or reconfiguration of IPE 300. Such firmware code is used to program the programmed state machine 316 or debug a problem in IPE 300. Maintenance block 318 should preferably contain a command queue (not shown) and decoding logic (not shown) that allow it to perform low level maintenance operation to IPE 300. In one implementation, maintenance block 318 should also be able to function without firmware because its primary responsibility is to perform firmware download operations to control store memory 320.

In terms of memory, control store memory is primarily used to supply programmed state machine 316 with instructions. Message queue memory 312 receives asynchronous messages sent by other elements for consumption by programmed state machine 316. Local memory 310 contains parameters and temporary storage used by programmed state machine 316. Local memory 310 also provides storage for certain information (such as headers, local data and pointers to memory) for transmission by data pump unit 304.

Data pump unit 304 contains a hardware path for all data transferred to and from external interfaces. Data pump unit 304 contains separate ‘transfer out’ (Xout) and ‘transfer in’ (Xin) data pumps that operate independently from each other as a full duplex. Data pump unit 304 also contains control logic for moving data. Such control is programmed into data pump unit 304 by programmed state machine 316 so that data pump unit 304 can operate autonomously so long as programmed state machine 316 supplies data pump unit 304 with appropriate information, such as memory addresses.

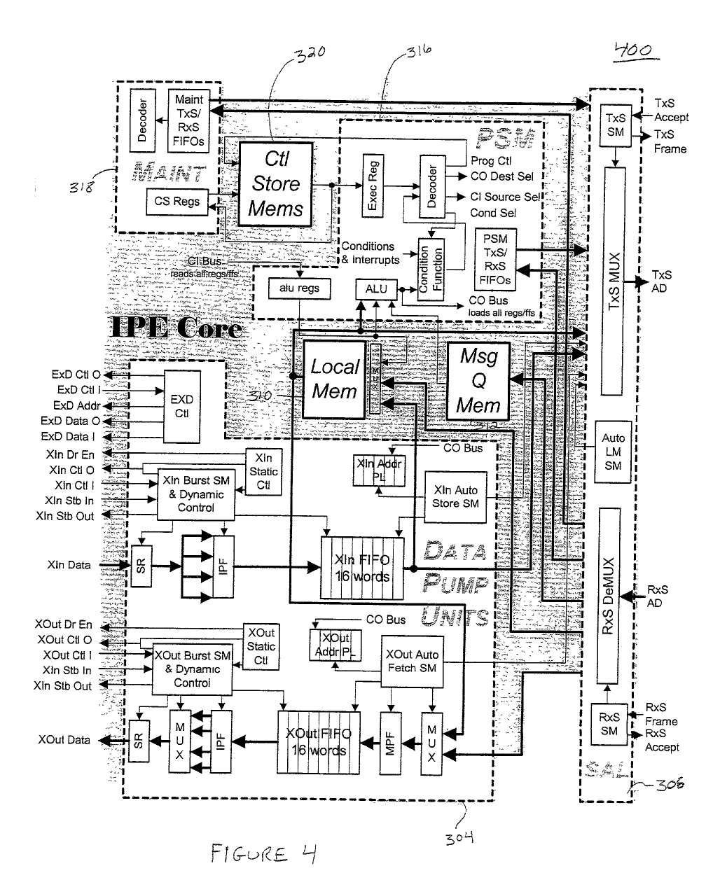

FIG. 4 shows a lower-level block diagram of an IPE 400, according to an illustrative embodiment of the present invention. IPE 400 is identical to IPE 300 except it shows more internal connections to enable one skilled in the art to easily design and implement an IPE. It should be noted that in the preferred embodiment, IPE 400 is substantially a synchronous device operating with a positive-edge system clock, although other clocking systems may easily be substituted. One advantage of IPE 400 is that its hardware core can easily be replicated to serve as a common hardware for all IPEs, and functionality of IPE 400 is configurable via their programmable state machine 316. Accordingly, by employing programmable state machines as the core of an IPE, manufactures of communication devices are able to reduce time-to-market focusing on core functionality in firmware, rather than a time consuming and tedious process of developing Application Specific Integrated Circuits (ASIC.)

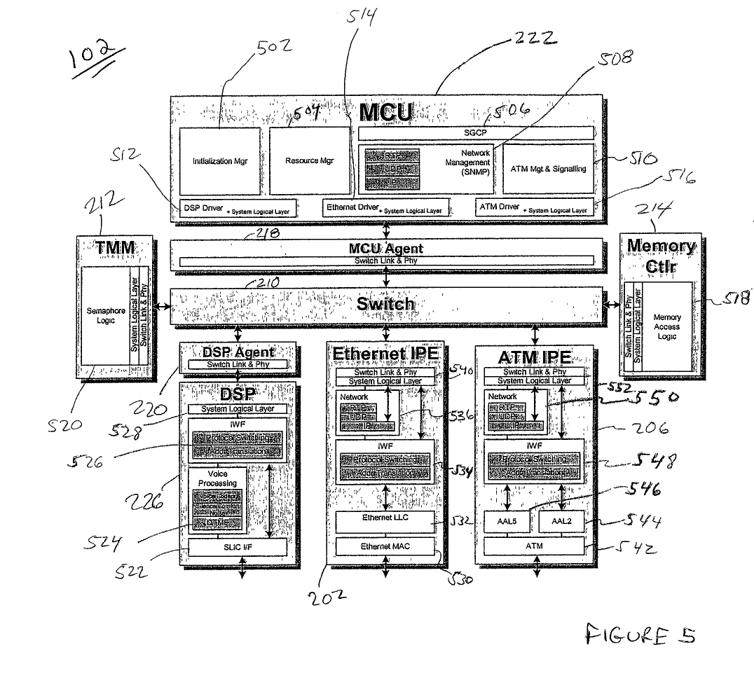

FIG. 5 is a functional architecture block diagram illustrating how primary functional attributes are partitioned in device 102. According to this example of the present invention, MCU 222 supports: call management initialization 502, resource management 504 of device 102, simple gate control protocols 506, network management (e.g., SNMP) 508, ATM management and signaling 510, a DSP driver 512, and driver functions (an Ethernet driver 514, and an ATM driver 516). TMM 212 contains semaphore logic that performs function coordination between devices connected to switch 210. DSP 220 contains all attributes associated with voice processing which is readily appreciated by those skilled in the art.

IPE 202 performs Ethernet protocol functions necessary to either send Ethernet data over DSL, or through the DSP to convert to voice. IPE 202 also performs Ethernet protocol functions to data received from other protocol mediums and encapsulates the data with control so that communication of the data is transferable to devices in an Ethernet protocol domain. In this embodiment, IPE 202 supports Ethernet I functionality including: Ethernet MAC 530 for LAN connections, Ethernet Logical Link Control (LLC) 532, Inner Working Function IWF 534, network layer, function for Internet Protocol 536, and system logical layer/switch link function 540.

IPE 206, performs ATM protocol functions necessary to either send data to the DSP to convert to audio or to IPE 202 for conversion to Ethernet. IPE also performs ATM protocol functions to data received from other protocol mediums and encapsulates the data in the form of cells so that communication of the data is transferable to devices in an ATM protocol domain. In this embodiment, IPE 206 performs and prioritizes functionality at International Telecommunication Union (ITU) standard levels AAL5 and AAL2. Of course, other ITU and OSI functionality could be supported in other IPEs depending on the application for which device 102 is implemented. Those skilled in the art will readily appreciate the level of functionality supported by device 102 based on a review of FIG. 5. Those skilled in the art will also readily appreciate that protocol level functionality may be allocated in many other combinations including distribution to more IPEs. Additionally, various levels of functionality supported in a protocol can be increased or diminished depending on the application of device 102.

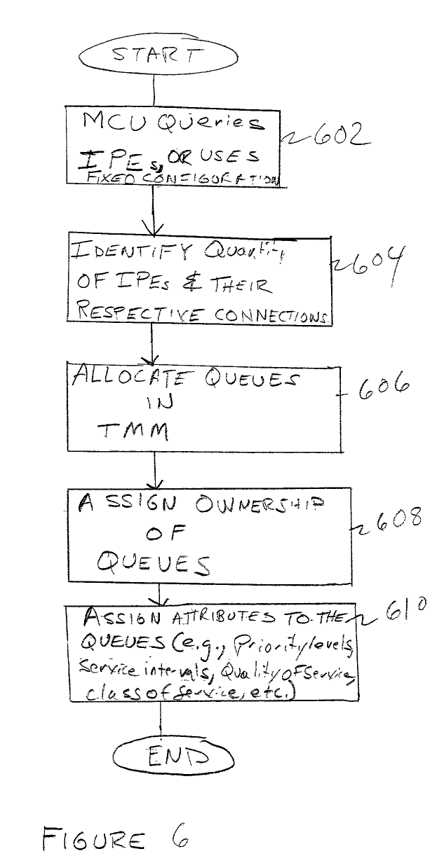

FIG. 6 is a flow diagram representing initialization of device 102 according to an illustrative embodiment of the present invention. In particular, steps 602-610 show how MCU 222 initiates assignment of functionality to queues (shown in FIG. 7) in TMM 212. For purposes of this example, reference shall be made to device 102 in FIG. 2. In steps 602 and 604, MCU 222 queries all IPEs 202-208 to identify the number of IPEs and their respective connection site in device 102.

Once the quantity and location of IPEs are determined, in step 606 MCU 222 instructs task manager 212 to allocate a quantity of queues (in the form of a first-in-first-out queue (FIFO) shown in FIG. 7) in the TMM 212 needed to provide functionality and track data flow in device 102. Each queue location serves as an allocation pointer to a particular function to be performed by an IPE 202-208 and syncs the function to data payloads associated with the function. The quantity of queues allocated in TMM 212 by MCU 222 depends on the protocol environments supported by device 102 and application robustness of equipment supported by device 102. In step 608, MCU 222 selects which particular IPE 202-208 shall own a particular queue. Assignment of queues is usually based on the functionality performed by a particular IPE 202-208. In step 610, MCU 222 assigns servicing queues 702, 704 to IPE 202-206. In this example, a high priority queue 702 ensures that when an IPE is processing information, it requests information from the high priority queue 702 first. If no information is available in the high priority queue, then IPE 202-208 removes tags and data from a low priority queue 704. More queues (not necessarily high and low priority queues) can be assigned to IPEs with heavier functional processing loads based on the servicing criteria of an IPE. Typically, a high priority queue 702 will be assigned to those tasks encompassing operations that are performed on real-time applications, such as framing/parsing, classification, modification, encryption/compression, and queuing. Whereas, a low priority queue 704 will be assigned to those tasks encompassing operations that involve bursty data. It should be noted that the aforementioned illustration of assigning queues to each IPE based on servicing criteria is for example purposes. For instance a single queue could be assigned to one IPE or multiple queues of varying sizes could be assigned to another IPE based upon the service criteria supported by the IPE. The concept of assigning high and low priority queues 702, 704 is for illustration purposes only.

FIG. 7 is a high-level block diagram representing queues 702, 704 employed in TMM 212 according to the illustrative embodiment of the present invention. As described above, each IPE 202-208 is typically assigned queues 702, 704, with servicing criteria, respectively. Each queue can also be assigned a high and low level watermark so that TMM 212 can notify MCU 222 in the event any queue is overloaded or underutilized. MCU 222 can thereby verify ‘on the fly’ if functionality performed by the IPEs is properly balanced and distributed evenly. MCU 222 may also reconfigure function allocation by modifying assignment of functions performed by one IPE to another IPE to better balance and distribute functionality. Thus, task performed by an IPE showing signs of being overloaded can be quickly assigned to one or more IPEs capable of performing those tasks (or reconfigured to perform those tasks) whose function allocation is under utilized or able to take-on increased functional work load.

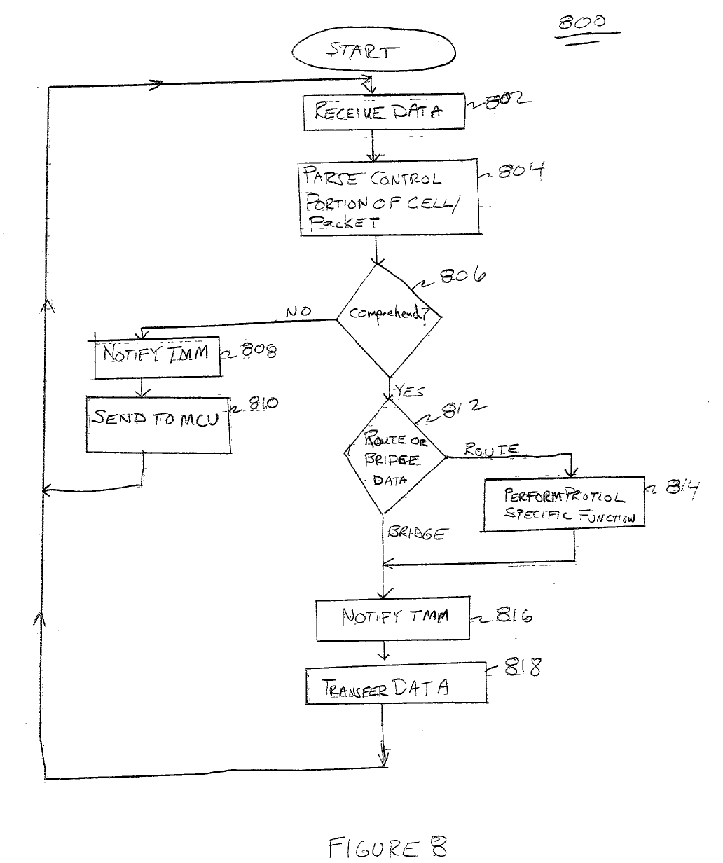

After TMM 212 is fully configured, device 102 may initiate operation. To better aid in describing the operation of device 102, a high-level example describing the operation of an IPE 202 is described with reference to FIG. 8. Referring to FIG. 8 steps 802-818 illustrate the overall operation of IPE 202 after receiving data off Ethernet wire 230. It shall be appreciated by those skilled in the art that this example could easily be adapted from one protocol environment to another and applied to other IPEs.

In step 802, IPE 102 (of FIG. 2) receives data in the form of an Ethernet frame (not shown, but those skilled in the art appreciate the composition of an Ethernet frame). IPE parses those portions of the frame it is able to strip from the payload portion. In a decisional step 806, IPE 202 determines if it comprehends the control portions of the frame. If it does not comprehend the control information, IPE 202 notifies TMM 212 that the control information needs to be transferred to MCU 222 for further processing. In step 810, TMM 212 notifies MCU 222 that control information is ready to be transferred when MCU 222 is ready to receive the information.

Assuming IPE 202 is able to comprehend the control portion of the frame, in a next decisional step 812, IPE 202 determines whether to route or bridge the information (typically the control portion of the frame). “Bridged” means the data can be immediately transferred out of IPE 202, whereas “routed” means more protocol intensive functional processing is performed to data. For instance, if data is encapsulated as an Internet Protocol (IP) packet in an Ethernet frame, then the data must be routed according to a step 814, whereby IPE 202 performs protocol specific functionality, which in this example includes stripping-off the Ethernet header and trailer. As a result, only the IP packet remains and is ready to be transferred to another device, such as IPE 206 for transmission over DSL via line 234.

Whether the data is bridged or routed, in a step 816, IPE 202 notifies TMM 212 that there is an item associated for IPE 206 (assuming in this example that it is Voice over IP to be sent over DSL). In either event, in step 818, TMM 212 sends a message through cross bar 210 to IPE 206 indicating that a packet is ready to be sent. IPE 206 retrieves the control information and performs egress functionality on the data to ensure transfer of its corresponding payload in memory 216 or local memory (shown in FIG. 3 as local memory 310) out of IPE 206.

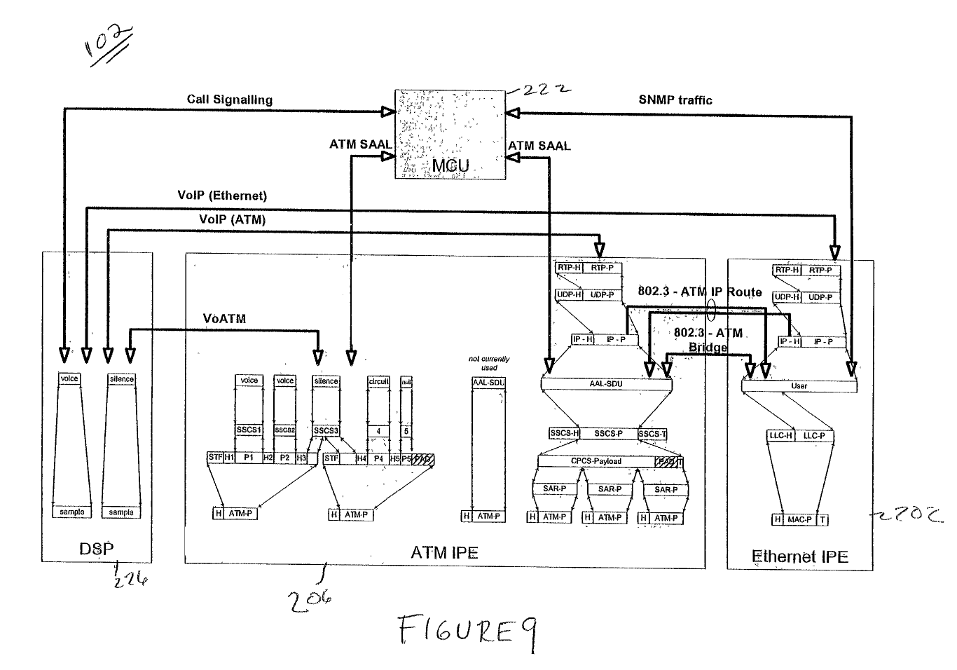

FIG. 9 is block diagram of a multi-protocol environment showing example traffic paths taken as data transcends protocol layers of functionality performed in IPE 206 and IPE 202. Notice that routing and bridging is shown between IPE 202 and 206. In this example, IPE 206 performs more functional level processing that could be off-loaded to IPE 207 (not shown) to better balance processing of functional loads. In essence, FIG. 9 shows that functional processing is pipelined and distributed throughout device 102.

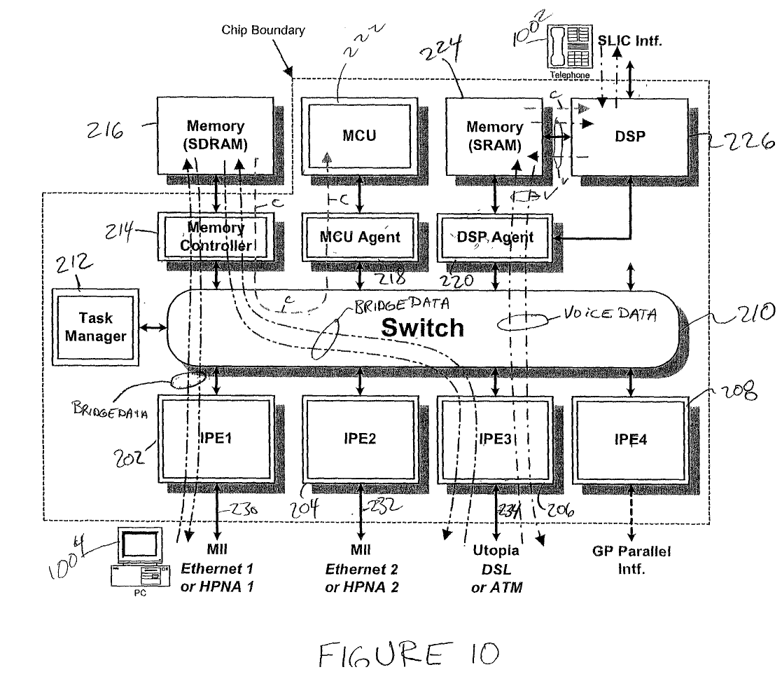

FIG. 10 is a block diagram of device 102 showing example data flow according to an illustrative embodiment of the present invention. In this example, voice data flows back and forth from a telephone 1002 through internal memory 224, DSP agent 220, cross bar 210 and through a port (IPE 206). Concurrently, bursty data flows to and from a computer 1004, through IPE 202, cross bar 210, memory controller 214, memory 216, back through memory controller 214 and switch 210 and egresses out of IPE 206 to possibly another DSL source (shown in FIG. 1 as end-user via 102B or 102C). Notice that MCU 222 main task, in this illustrative example, is to initiate call management (“C”) between device 102 and the telephone 1002. Streaming media in the form of interactive real-time data and even bursty data flows through device 102 in a distributed fashion without burdening MCU 222. FIG. 10 allows those skilled in the art to appreciate that the present invention distributes functional processing to multiple functional blocks 202-208, 226 so that real-time data is not delayed by processing domains associated with conventional processor architectures. Additionally, by programmably configuring functional blocks 202-208, device 102 is able to adjust and balance functional loading on a dynamic basis.

The foregoing description of embodiments of the present invention has been presented for purposes of illustration and description only. It is not intended to be exhaustive or to limit the invention to be forms disclosed. Obviously, many modifications and variations will be apparent to practitioners skilled in the art.

What is claimed is:

1. A device for communicating in at least one protocol environment comprising:
a plurality of interconnected functional blocks programmably configurable to perform portions of processing appurtenant to said communicating; and
a function allocator, associated with said plurality of functional blocks, that allocates said portions among said functional blocks based on an identity of said at least one protocol environment.

2. The device of claim 1, wherein in said protocol is adapted to handle streaming media.

3. The device of claim 1, wherein is said protocol environment is a class of service.

4. The device of claim 2, wherein said streaming media contains video.

5. The device of claim 2, wherein said streaming media contains audio.

6. The device of claim 3, wherein said plurality of functional blocks perform processing appurtenant to said communicating by distributing data associated with said processing among said plurality of functional blocks according to priorities associated with the protocol environment.

7. The device of claim 1, further comprising a cross bar that interconnects said functional blocks to allow point-to-point transfer of data between said functional blocks.

8. The device of claim 6, further comprising a processor interconnected to said functional blocks for processing data in parallel with said functional blocks whereby said functional blocks and said processor are configured to operate on a peer-to-peer basis.

9. The device of claim 8, wherein at least one of said functional devices is configured to process latency sensitive data necessary to comply with the at least one protocol environment and wherein said processor is configured to process data that is less time critical than said latency sensitive data.

10. An architecture for dynamically distributing protocol functionality in a communication device, comprising:
a plurality of functional blocks configured to dynamically allocate and balance performance of latency sensitive tasks associated with at least one protocol among at least a portion of said plurality of functional blocks;
a dynamic communication path, connected to at least a portion of said plurality of functional blocks, configured to provide dynamic transfer of tasks between said plurality of functional blocks; and
a processor, interconnected to said communication path and said plurality of function blocks, configured to operate on a peer-to-peer basis with said plurality of functional blocks.

11. The architecture of claim 10, wherein said latency sensitive tasks include protocol functionalities associated with streaming media.

12. The architecture of claim 10, wherein said dynamic communication path is a cross bar configured to provide point-to-point transfer of said tasks between said plurality of functional blocks.

13. The architecture of claim 10, wherein said functional blocks are programmably configured to perform at least portions of tasks associated with said protocol.

14. The architecture of claim 10, wherein said processor is further configured to handle processing tasks unable to be performed by said functional blocks.

15. The architecture of claim 10, wherein the architecture is embedded on a chip.

16. The architecture of claim 10, wherein said processor does not interrupt said functional blocks while performing said latency sensitive tasks.

17. A distributed communication system for balancing processing of real-time communication applications, comprising:
a plurality of functional devices, configured to perform real-time communication tasks and dynamically distribute said real-time communication tasks among said plurality of functional devices to balance functional processing loading among at least a portion of said plurality of functional devices;
a cross bar, interconnecting said plurality of functional devices, configured to provide point-to-point communication between said functional devices;
a central processor connected to said cross bar, configured to operate in parallel with said plurality of functional devices and to minimize interrupting real-time communication tasks performed by said plurality of functional devices.

18. The distributed communication system of claim 17, wherein said central processor is regulated to processing tasks not associated with real-time communication.

19. The distributed communication system of claim 17, further comprising an ingress port and egress port connected to said functional devices, wherein data, associated with performing said real-time communication tasks, flows from said ingress port to said egress port without the need for said central processor to control and interrupt said data flows.

20. The distributed communication system of claim 17, wherein said functional devices are programmably configurable.
